(19) United States
(12) Patent Application Publication
(10) Pub. No.: US 2007/0052518 A1
(43) Pub. Date: Mar. 8, 2007

(54) Security management device, security management method, security management program, and computer-readable recording medium

(75) Inventor: Akihiko Nakamura, Kyoto (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 10/557,484

(22) PCT Filed: Sep. 7, 2004
(86) PCT No.: PCT/JP04/12998

§ 371 Date: Nov. 21, 2005

(30) Foreign Application Priority Data
Sep. 26, 2003 (JP) 2003-335351

(51) Int. Cl. G05B 19/00

(52) U.S. Cl. 340/5.3; 340/10.41; 340/541

(57) ABSTRACT

A security management device includes: an at-home determination section (18b) for determining whether or not a member is present in a security management region; a member information obtaining section (19) for obtaining member attribute information of the member determined to be present in the security management region by the at-home determination section; and an external processing decision section (21) for changing the security management mode in the security management region in such a way where the external processing corresponds to the member attribute information obtained by the member information obtaining section (19) when no unauthorized invasion is detected by an unauthorized invasion detection section (18a).

### TECHNICAL FIELD

The present invention relates to a security management device using member authentication.

### BACKGROUND ART

There have been suggestions for a variety of methods for managing security in a place where a person spends a certain period of time for living or working, such as a house, a working place, a school, or others (the place will be referred as, simply, “a house” hereinafter).

For example, in Reference 1 (Japanese Patent Application Publication No. 6-141093, published on May 20, 1994), a cordless telephone is disclosed. As illustrated in FIG. 8, the cordless telephone includes: a cordless handset identification signal storage section 103 that stores an identification signal for identifying a cordless handset, a comparison determination section 104 that compares (i) an addresser identification signal of a cordless handset 113 that currently has a wireless link and (ii) a content of the cordless handset identification signal storage section to determine whether or not the cordless handset is a certain cordless handset, a timer section 105 that starts up when a signal indicating that the cordless handset is the certain cordless handset is outputted from the comparison determination section 104 and that can restart even after having been started up, a start detection section 106 that detects a start-up of the timer section 105, a time-out detection section 107 that detects a time-out of the timer section 105, a returning notification section 108 that outputs a returning confirmation signal upon receiving an output signal from the start detection section 106, and a leaving notification section 110 that outputs a leaving confirmation signal upon an receiving output signal from the time-out detection section 107. The cordless telephone confirms whether a certain cordless handset 113 is present so as to detect the returning, leaving, staying, or other movements of a person.

In the cordless telephone structured as described above, based upon the signal from the returning notification section 108, the staying notification section 109, and the leaving notification section 110, the device control section 111 provides an instruction to a lighting control instrument 115 to turn on/off lighting and/or an air-conditioner control instrument 116 to activate an air-conditioner, through communication instrument 114.

### DISCLOSURE OF INVENTION

However, in the reference art described in Reference 1, no association is made between the cordless telephone and a member using the cordless telephone. Therefore, the reference art described in Reference 1 can only detect the entering/exiting of the cordless telephone but cannot detect who enters/exits the zone.

Accordingly, operation of the domestic devices that is actualized with the cordless telephone in Reference 1 would be carried out uniformly and irrelevantly to who the member carrying the cordless telephone is.

For example, it is dangerous if a child to use a gas appliance, so it is preferable that a gas appliance or the like be not available when the member entering the zone and using the cordless telephone is a child. In the reference art, however, because no association is made between the cordless telephone and the member using the cordless telephone, as described above, processing is carried out uniformly. For example, the gas appliance is caused to be unavailable or available in such a way as to be irrelevant as to who the member using the cordless telephone is.

In view of the above problem in the reference art, the present invention has as an object to provide a security management device that can set a security management mode appropriate for a member in a security management region that is subject to security management, a security management method, a security management program, and a computer-readable recording medium.

A security management device in the present invention is arranged in that the security management device includes an unauthorized invasion detection instrument that detects an unauthorized invasion to a security management region that is subject security management, and raises an alarm when the unauthorized invasion detection instrument detects an unauthorized invasion. Further, in order to solve the above problem, the security management device includes (i) a presence/absence determination means that determines the presence/absence of a member in the security management region, (ii) a member information obtaining means that obtains attribute information of a member whom the presence/absence determination instrument determines as being present in the security management region, and (iii) a security management mode changing instrument that, in a case in which the unauthorized invasion detection instrument detects no unauthorized invasion, changes a security management mode in the security management region based upon the attribute information of the member obtained by the member information obtaining instrument.

Further, a security management method in the present invention is arranged in that an unauthorized invasion detection instrument in a security management device is operable to detect an unauthorized invasion into a security management region that is subject to security management, and the security management device raises an alarm when the unauthorized invasion is detected by the unauthorized invasion detection instrument. The security management method is characterized in that it includes (i) a first step in which presence/absence of a member in the security management region is determined by the presence/absence determination instrument in the security management device, (ii) a second step in which attribute information of a member whom the presence/absence determination instrument determines as being present in the security management region is obtained by a member information obtaining instrument in the security management device, and (iii) a third step in which a security management mode in the security management region is changed by the security management mode changing instrument in the security management device based upon the attribute information of a member obtained by the member information obtaining instrument, in a case in which the unauthorized invasion detection instrument detects no unauthorized invasion.

In the above structure, by using the presence/absence determination instrument, it can be determined whether or not a member is present in the security management region, for example, in a house. Then, the member information obtaining instrument obtains attribute information of the member determined as being present in the house. Consequently, attributes of the member being present in the house can be ascertained. The term “member” includes not only a person but also a pet animal such as a dog or a cat.

Further, in the present invention, because the security management mode changing instrument changes the security management mode based upon the attribute information of a member obtained by the member information obtaining instrument, the security management mode is changed in such a way as to correspond to the attribute of the member present in the security management region. Therefore, the present invention enables the security management mode to be appropriately set for the member being present in the security management region.

Further aims, features, and advantages of the present invention will be fully understandable from the description below. In addition, the merits of the present invention will also be clear from the following description with reference to the accompanying drawings.

### BRIEF DESCRIPTION OF DRAWINGS

FIG. 1 is a block diagram that illustrates a structure of an embodiment of a security management device in the present invention.

FIG. 2 is a figure that illustrates a structure of a security management system using a security management device and a member information recording medium of the present invention.

FIG. 3 is a block diagram that illustrates an exemplary structure of a member information recording medium of the present invention.

FIG. 4 is a block diagram that illustrates a structure of a domestic device control section in the security management system in FIG. 2.

FIG. 5 is a block diagram that illustrates a structure of a center system in the security management system in FIG. 2.

FIG. 6 is a flow chart that illustrates a flow of processing carried out in the security management system in FIG. 2.

FIG. 7 is a flow chart that illustrates another flow of processing carried out in the security management system in FIG. 2.

FIG. 8 is a figure that illustrates a structure of a conventional cordless telephone for security management.

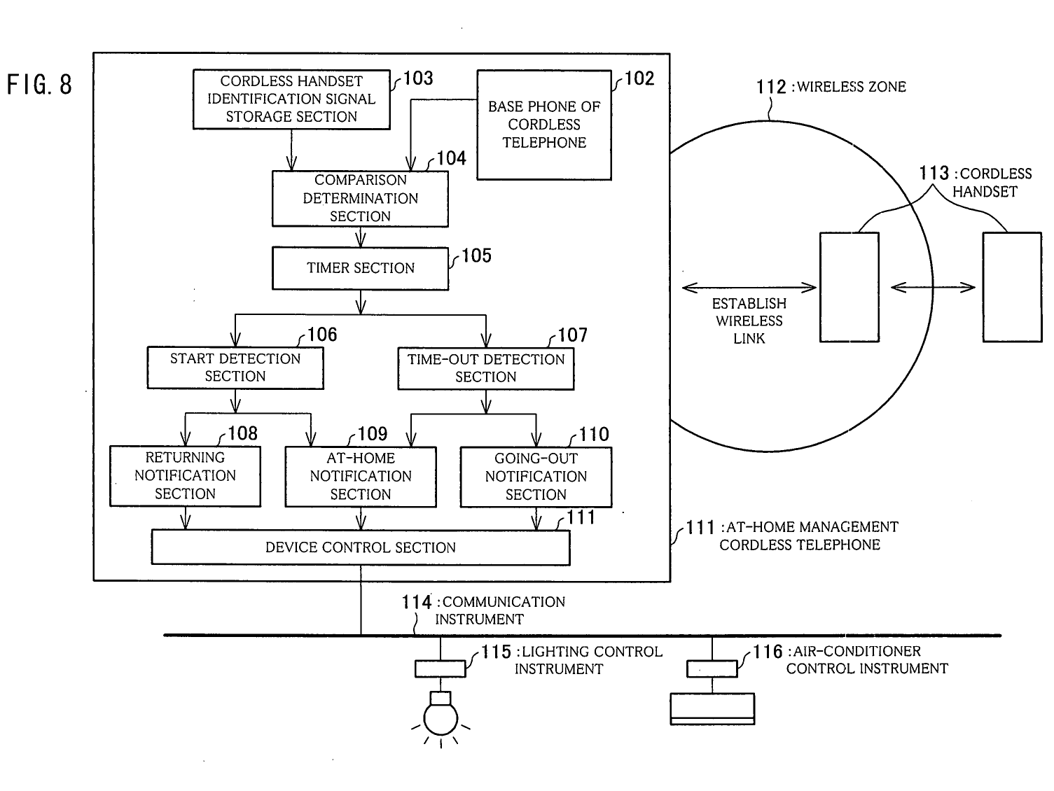

### BEST MODE FOR CARRYING OUT THE INVENTION

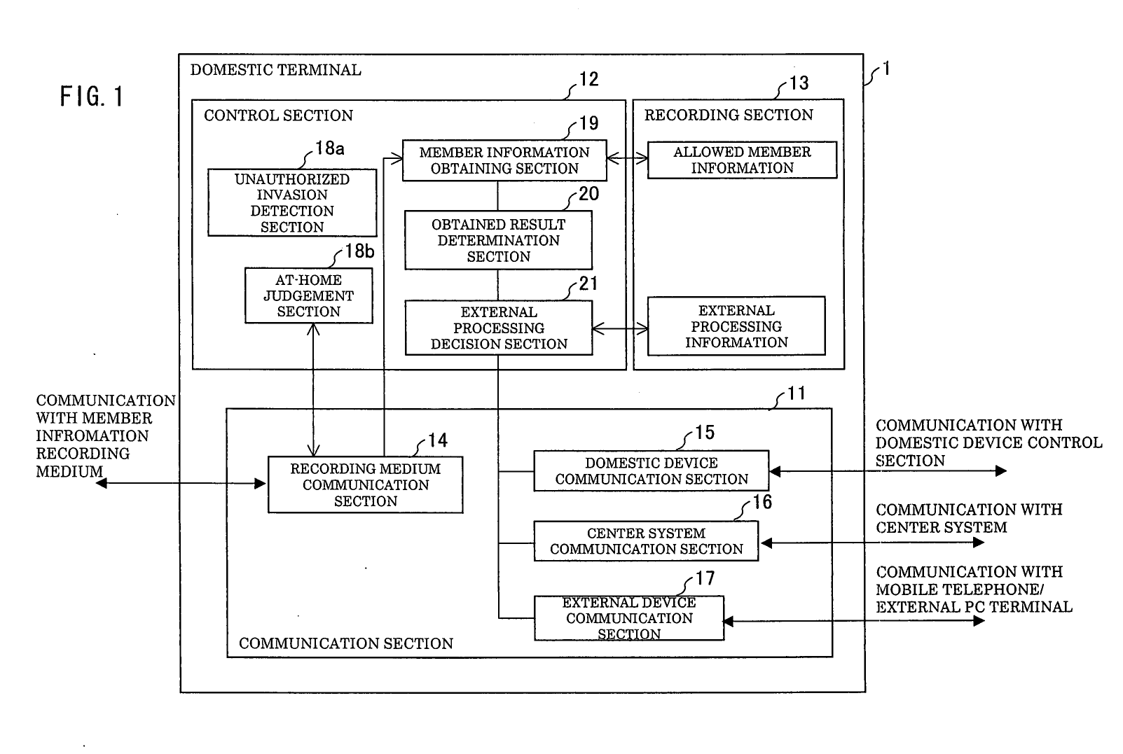

The following describes an embodiment of a security management system using a security management device of the present invention, with reference to FIGS. 1 to 7.

[1. Structure of the System]

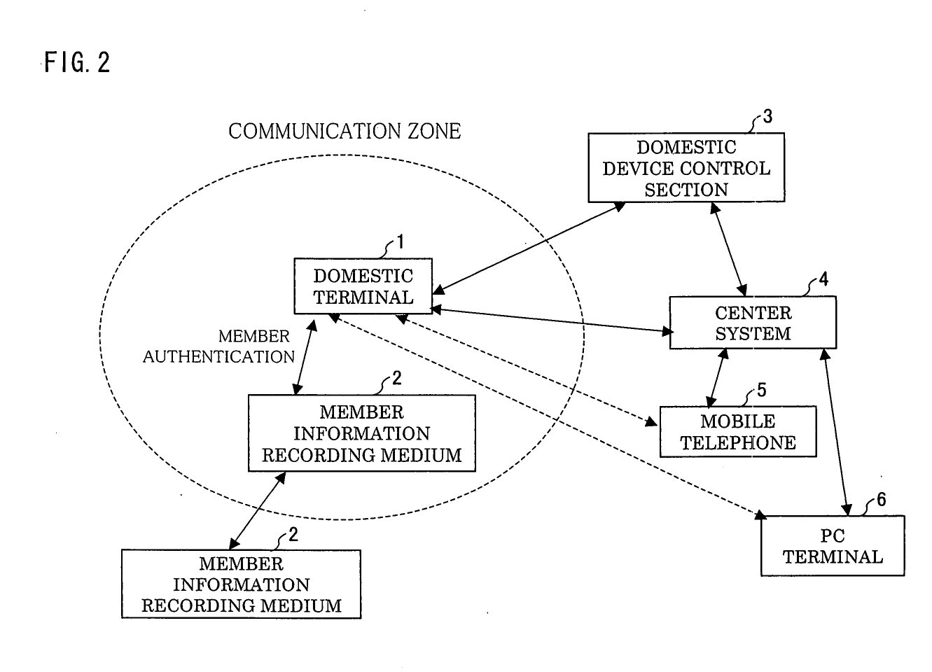

As illustrated in FIG. 2, the security management system in the embodiment includes a domestic terminal (security management device) 1 and a member information recording medium 2.

The domestic terminal 1 is disposed in a house and can carry out short-distance wireless communication with the member information recording medium 2 within a communication zone. Communicating with the member information recording medium 2, the domestic terminal 1 obtains therefrom ID information/attribute information of a member, the information being stored in the member information recording medium. For the short-distance wireless communication, communication in accordance with a wireless LAN standard at a frequency of 2.4 GHz (gigahertz), or a Blue-Tooth (registered trademark) standard communication method using weak radiowave, may be used as the short-distance wireless communication. A structure and function of the domestic terminal 1 will be described below.

The member information recording medium 2, as described above, records the following information as member information for authenticating a member carrying the member information recording medium 2: ID information for identifying the member, or attribute information indicating attribute of the member. It is desirable that the member information recording medium 2 employs a medium that a member can handily carry and that can record member information. Examples of the medium include an IC card, a mobile telephone, or the like. Further, the member information recording medium 2 can be carried by a pet animal by disposing the member information recording medium 2 on an accessory, such as a collar or clothing, that the pet wears.

As the ID information, both unprocessed or encrypted information regarding a name of the member may be used. As the attribute information, information indicating sex, age, height, weight, physical condition, or the like, of the member may be used. A structure and function of the member information recording medium 2 will be described below.

Further, the domestic terminal 1 communicates with a domestic device control section (external device) 3 and a center system (external device) 4, based upon the ID information or the attribute information of the member obtained from the member information recording medium. In addition, the domestic terminal 1 causes the domestic device control section (external device) 3 and the center system to carry out a predetermined processing that is appropriate for the member carrying the member information recording medium 2.

The domestic device control section 3 controls an operation of a household appliance such as a lighting device, an air-conditioner, a stove, or a hot-water supplier, in a house on which the domestic terminal 1 is disposed. Communicating with the domestic terminal 1, the domestic device control section 3 controls the household appliance in the house so as to carry out an operation that is appropriate for the member, based upon a result of the member information obtained by the domestic terminal 1 of the member carrying the member information recording medium 2. A structure and function of the domestic device control section 3 will be described below.

A center system 4 solely controls information communication between a plurality of domestic terminals, a plurality of domestic device control sections, a plurality of mobile telephones, and a plurality of PC (Personal Computer) terminals. Although it is illustrated in FIG. 2 that one domestic terminal 1, one domestic device control section 3, or others are connected to the center system 4 for communication, it should be understood that a plurality of domestic terminals, a plurality of domestic device control sections, or other devices may be connected to one center system 4 for communication.

Communicating with the domestic terminal 1 as described above, the center system 4 instructs the domestic device control section 3 to carry out processing that is appropriate for the member, based upon a member information obtaining result obtained from the domestic terminal 1 of the member carrying the member information recording medium 2. In addition, the center system 4 transmits an electronic mail/audio message that is appropriate for the member whom the center system 4 authenticates to a mobile telephone (external device) 5 or a PC terminal (external device) 6. A structure and function of the center system 4 will be described below.

The domestic terminal 1 may be structured in such a way where a network such as the Internet is established between the domestic terminal 1 the mobile telephone 5 or the PC terminal 6. The domestic terminal 1 may carry out predetermined processing with the mobile telephone 5 or the PC terminal 6, based upon the result of authentication of the member information recording medium 2 carried out by the domestic terminal 1. This structure will be described below.

With the structure described above, in the security management system of the present embodiment, the domestic terminal 1 obtains member information of a member carrying the member information recording medium 2. Based upon the obtained result, the domestic device control section 3 or the center system 4 carries out processing that is appropriate for the member. The following describes in detail a structure and function of the respective elements constructing the above-described security management system described above.

[2. Structure of the Member Information Recording Medium]

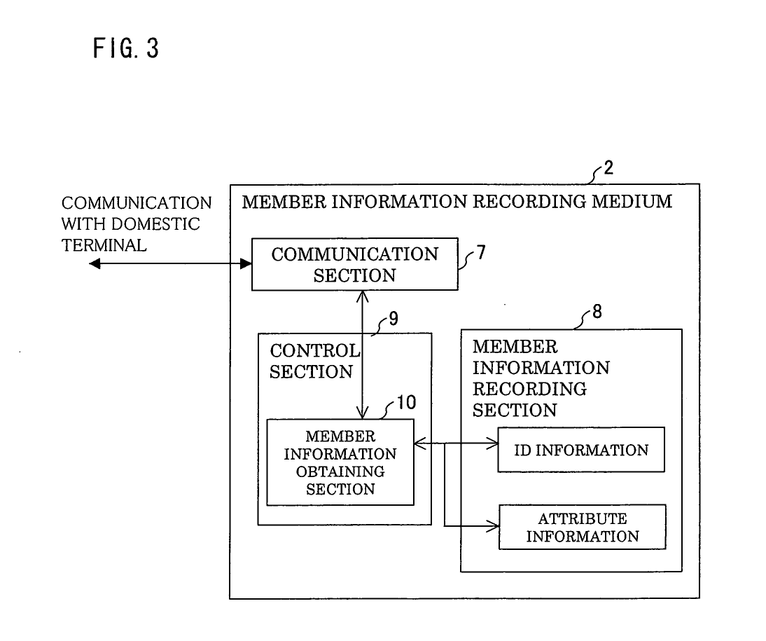

The following describes a structure and function of the member information recording medium 2. As illustrated in FIG. 3, the member information recording medium 2 includes communication section 7, a member information recording section 8, and a control section 9.

The communication section 7 is an interface circuit for communicating with an external device and realizing communication with the domestic terminal 1. For example, if the member information recording medium 2 is an IC card, the communication section 7 is realized with an antenna coil that uses, as a power supply for itself, a part of the energy released by the domestic terminal working as a reader/writer. If the member information recording medium 2 is a mobile telephone, the communication section 7 is realized with a communication circuit that provides mobile telephone communications in the mobile phone.

The member information recording section 8 is for recording the above-described ID information/attribute information as the member information used in the authentication of the member carrying the member information recording medium 2. Because the ID information is information by which the member can be identified, in view of privacy protection and prevention of abusive usage, it is preferable that the ID information be unchangeable after being written in the member information recording section 8. Therefore, it is preferable that the ID information recording section in the member information recording section 8 be structured with a recording medium, such as a field-programmable ROM, in which writing is allowed only once, and that storing of the ID information be carried out when the member information recording medium 2 is used for the first time.

In the attribute information, while information indicating sex of a member basically remains unchanged throughout the lifetime, information indicating age, height, weight, physical condition, and the like change as time goes by. Therefore, it is preferable that the attribute information be recorded in the member information recording medium 2 in such a way as to be rewritable. Accordingly, it is preferable that an attribute information recording section in the member information recording section 8 be constructed with a rewritable recording medium such as an EEPROM (Electrically Erasable Programmable Read Only Memory).

The control section 9 solely controls processing in the member information recording medium 2. Especially, the control section 9 includes a member information obtaining section 10 that obtains ID information/attribute information from the member information recording section 8. The member information obtaining section 10 obtains the member information in accordance with a request for obtaining member information from the domestic terminal 1 through the communication section 7. Obtained information is transmitted from the communication section 7 to the domestic terminal 1.

In the above structure, the member information recording medium 2 communicates with the domestic terminal 1 through the communication section 7. Based upon a content of the communication, the member information recoding medium 2 reads out the ID information/attribute information recorded in the member information recording section 8 through the member information obtaining section 10. Further, the member information recording medium 2 transmits the ID information/attribute information to the domestic terminal 1 through the-communication section 7.

[3. Structure of the Domestic Terminal]

The following describes a structure and function of the domestic terminal 1. As illustrated in FIG. 1, the domestic terminal 1 includes a communication section 11, a control section 12, and a recording section (recording instrument) 13.

The communication section 11 is an interface circuit for communicating with an external device and includes: a recording medium communication section (member information recording medium communication instrument) 14 that realizes short-distance wireless communication with the member information recording medium 2, a domestic device communication section (external device notification instrument) 15 that realizes communication with the domestic device control section 3, a center system communication section (external device notification instrument) 16 that realizes communication with the center system 4, and an external device communication section (external device notification instrument) 17 that realizes communication with the mobile telephone 5 or the PC terminal 6.

The control section 12 solely controls processing in the domestic terminal 1 and includes: an unauthorized invasion detection section (unauthorized invasion detection instrument) 18a, an at-home determination section (at-home determination instrument) 18b, a member information obtaining section (member information obtaining instrument) 19, an obtained result determination section 20, and an external processing decision section (security management mode changing instrument) 21.

The unauthorized invasion detection section 18a detects whether or not there has been an unauthorized invasion in the house. As the unauthorized invasion detection section 18a, a vibration sensor that detects an effraction via a door such as a turning of a thumb or an picking of a lock, or others may be used.

The at-home determination section 18b determines whether or not the member of the member information recording medium is present in the house. Processing for deciding whether or not the member is present in the house (the processing will be referred as an at-home determination processing hereinafter) may be carried out by, for example, determining whether or not a member information recording medium 2 that with which communication can be established is present in a zone in which a short-distance wireless communication can be carried out through the recording medium communication section 14.

The communication zone must be set in such a way as to cover an entire region in the house in which a member may move around. If the communication zone fails to cover the entire region, the recording medium communication section 14 will be unable to reach the member information recording medium 2. Consequently, the at-home determination section 18 may determine that no member is present in the house although there is a member being present in the house.

The at-home determination processing is not limited in the above-described way. For example, the at-home determination processing can be carried out by disposing a pyroelectric sensor or an area sensor in the house and by detecting with the sensor whether or not anyone is present in the house. In addition, the at-home determination processing can be carried out by determining whether or not a footwear of a certain member is present at a certain position in a footwear cupboard. Further, the at-home determination processing can be carried out by determining whether or not anyone is caught by a video camera disposed in the house.

The member information obtaining section 19 carries out member authentication processing by obtaining ID information/attribute information recorded in the member information recording section 8 (FIG. 3) of the member information recording medium 2 through the recording medium communication section 14.

The term “member authentication processing” implies (i) determination processing for determining whether or not the member information recording medium 2 has rightful ID information and (ii) processing in which member attribution necessary for carrying out the below-mentioned external processing is determined based upon the member attribution information.

The determination process in which it is determined whether or not the member information recording medium 2 has rightful ID information is carried out by comparing (i) allowed member information recorded in the recording section 13 in the domestic terminal 1 and (ii) ID information in the member information recording medium 2, the ID information obtained through the recording medium communication section 14.

The allowed member information recorded in the recording section 13 in the domestic terminal 1 indicates the ID of the member allowed to be in the house, examples of such members including an inhabitant, a friend, a relative, a pet-animal, or others. Therefore, the member information obtaining section 19 can determine whether or not the member information recording medium 2 has rightful information by determining whether or not the ID information obtained through the recording medium communication section 14 is included in the allowed member information.

Ways of determining whether or not a member has a rightful ID are not limited to the above-mentioned method in which ID information in the member information recording medium 2 is obtained and is used in the determination. For example, biometric instruments such as a finger-print-recognition device, a face-recognition device, a retina-recognition device, an iris-recognition device, or an audio-recognition device may be included in the domestic terminal 1, and member authentication may be carried out by using the built-in biometric instrument.

The obtained result determination section 20 determines a result of the member information obtained by the member information obtaining section 19 and transmits information regarding the result (obtained result information) to the external processing decision section 21. For example, when the member information obtaining section 19 determines that the member of the member information recording medium 2 has a rightful ID, an obtained result information indicating that the member has a rightful ID is transmitted to the external processing decision section 21. The obtained result determination section 20 may transmit to the external processing decision section 21 information indicating an attribution of the member as determined by the member information obtaining section 19.

The external processing decision section 21 determines an external process to be carried out by an external device such as a domestic device, a center system, or the like. This determination is made based upon the obtained result information transmitted from the obtained result determination section 20. More specifically, the external processing decision section 21 determines an external process to be carried out by referring to the obtained member information result information and the external processing information recorded in the recording section 13.

The external processing information is information in which an ID information or an attribute information of members and a list of external processes are associated. Therefore, the external processing decision section 21 determines the ID information/attribute information of a member based upon the obtained result information and refers to the list of external processes that is associated with the ID information/attribute information so as to determine on the list of external processes to be carried out.

In addition, the external processing decision section 21 creates information which indicates a list of external processes that has been determined by the external processing decision section 21 to be carried out (external processing execution information). Moreover, the external processing decision section 21 transmits the information respectively to the domestic device communication section 15, the center system communication section 16, and the external device communication section 17, all of which are in the communication section 11. In other words, if the external process is a process that should be carried out by a domestic device such as a lighting device, an air-conditioner, a stove, or a hot-water supplier, the external processing decision section 21 transmits to the domestic device communication section 15 the external process execution information.

The domestic device communication section 15 transmits to the domestic device control section 3 (FIG. 2) the external processing execution information received from the external processing decision section 21. In a similar manner, if the external process is one that should be carried out by the center system, the external processing decision section 21 transmits to the center system communication section 16 the external processing execution information. The center system communication section 16 transmits to the center system 4 (FIG. 2) the external processing execution information received from the external processing decision section 21.

If the list of external processes is a process of transmitting a message to the mobile telephone 5 (FIG. 2) or to the PC terminal 6 (FIG. 2), the external processing decision section 21 transmits to the external device communication section 17 the external processing execution information. Based upon the external processing execution information received from the external processing decision section 21, the external device communication section 17 transmits a message including predetermined content to the mobile telephone 5 or to the PC terminal 6. Detailed description of the message will be presented below.

As described above, in the domestic terminal 1, the member information obtaining section 19 determines ID information/attribute information of the member of the member information recording medium 2. In addition, execution of a predetermined process is instructed through the communication section 11 to the domestic device control section 3, the center system 4, the mobile telephone 5, PC terminal 6, or others.

[4. Structure of Domestic Device Control Section]

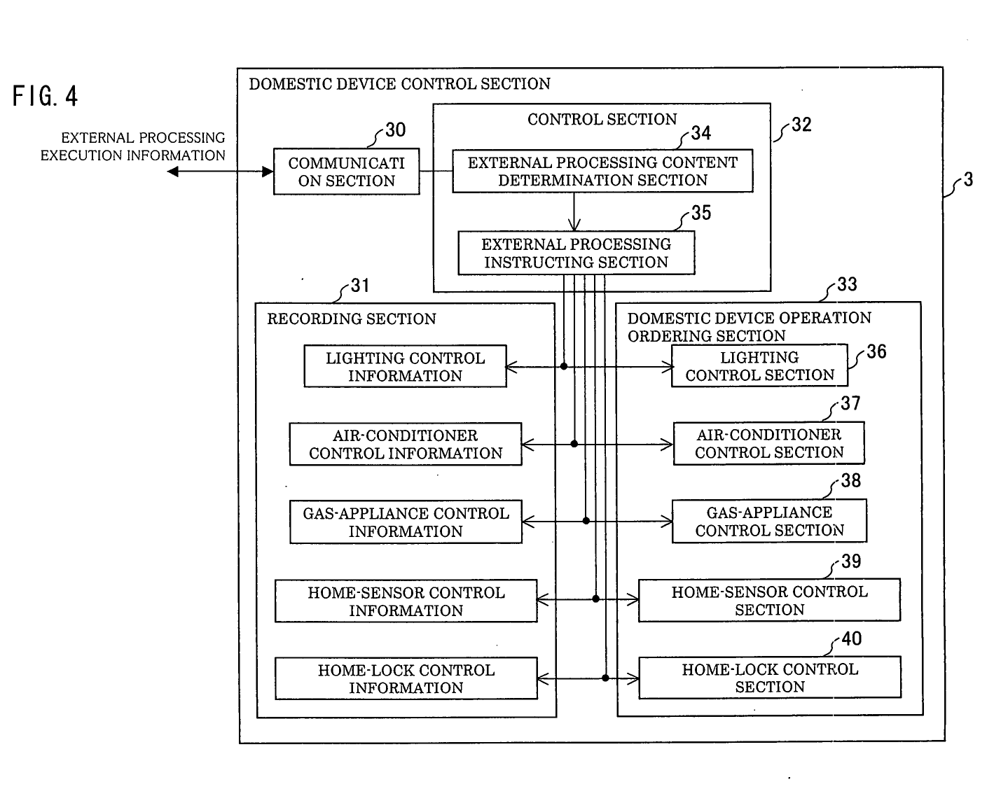

The following describes a structure and function of the domestic device control section 3. As illustrated in FIG. 4, the domestic device control section 3 includes a communication section 30, a recording section 31, a control section 32, and a domestic device operation ordering section 33.

The communication section 30 communicates with the domestic device communication section 15 (FIG. 1) in the domestic terminal 1 and with the center system 4. Communication between the domestic device communication section 15 and the communication section 30 may be via a wire or wireless communication. The communication section 30 receives external processing execution information indicating a list of external processes determined by the external processing decision section 21 in the domestic terminal 1, from the domestic device communication section 15.

The recording section 31 records various information necessary for carrying out processing in the domestic device control section 3. The recording section 31 records the following information: lighting control information for controlling operation of a lighting device, air-conditioner control information for controlling operation of an air-conditioner, gas-appliance control information for controlling operation of a gas-appliance, home-sensor control information for controlling operation of a home-sensor, and home-lock information for controlling operation of a home-lock.

The home-sensor implies a sensor disposed to assure security in a house. Examples of the sensor are: a crime-prevention sensor disposed in a house, for example, on an entrance, on a door, or on a window, a gas-leakage sensor that detects gas-leakage, and a fire sensor that detects unusual rises in temperature in a house. The home-lock implies a lock on an entrance, on a door, on a window, or others in a house.

The control section 32 solely controls processing in the domestic terminal 1. The control section 32 includes an external processing content determination section 34 and an external processing instructing section 35.

The external processing content determination section 34 determines which domestic device should carry out which processing, based upon the external processing execution information that the communication section 30 receives. In accordance with the determination by the external processing content determination section 34, the external processing instructing section 35 gives the subsequent domestic device operation ordering section 33 an operation control instruction for the respective domestic devices.

The domestic device operation ordering section 33 controls operation of the respective domestic devices in accordance with the operation control order from the external processing instructing section 35. The following describes a structure in which the domestic device operation ordering section 33 includes a lighting control section 36 that controls operation of a lighting device, an air-conditioner control section 37 that controls operation of an air-conditioner, a gas-appliance control section 38 that controls operation of a gas-appliance, a home-sensor control section 39 that controls operation of a home-sensor, and a home-lock control section 40 that controls operation of a home-lock. Other control instruments that control operation of a domestic device may also be further included.

Each of the sections included in the domestic device operation ordering section 33 reads out from the recording section 31 control information for making a domestic device carry out operation corresponding to the operation control order from the external processing instructing section 35, and controls the operation of the domestic device.

For example, the lighting control section 36 reads out from the lighting control information in the recording section 31 control information for making a lighting device carry out an operation in accordance with the operation control order of the lighting device, and thereby controls an operation of the lighting device. In a similar manner, the air-conditioner control section 37 controls operation of an air-conditioner in accordance with the air-conditioner control information. The gas-appliance control section 38 controls operation of a gas-appliance in accordance with the gas-appliance control information. The home-sensor control section 38 controls operation of a home-sensor in accordance with the home-sensor control information. The home-lock control information controls operation of a home-lock in accordance with the home-lock control information.

Having the structure described above, the domestic device control section 3 controls operation of the domestic devices such as an air-conditioner, a gas-appliance, a home-sensor, or the like, in accordance with the external processing execution information transmitted from the domestic terminal 1. As described above, the external processing execution information is created by the external processing decision section 21 in the domestic terminal 1 in such a way as to be associated with the ID information/attribute information of the member. Therefore, the domestic device control section 3 can make the domestic device carry out operation corresponding to the ID information/attribute information of the member.

[5. Structure of the Center System]

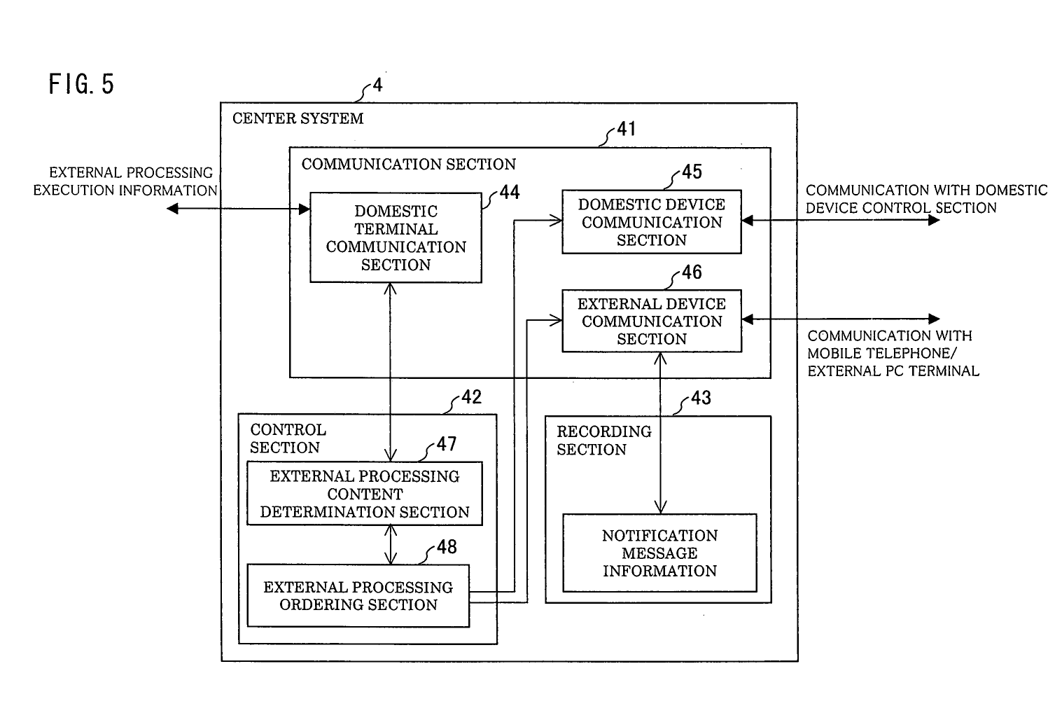

The following describes a structure and function of the center system 4. As illustrated in FIG. 5, the center system 4 includes communication section 41, a control section 42, and a recording section 43.

The communication section 41 solely carries out communication between the center system 4 and an external device. The communication section 41 includes a domestic terminal communication section 44, a domestic device communication section 45, and an external device communication section 46.

The domestic terminal communication section 44 carries out communication with the center system communication section 16 in the domestic terminal 1 and receives external processing execution information created by the external processing decision section 21 in the domestic terminal 1. As described above, a plurality of domestic terminals 1 are connected to one center system 4. Therefore, it is preferable that communication between the domestic terminal communication section 44 and the center system communication section 16 be carried out by using a network communication such as telephone line network or internet communication network.

The domestic device communication section 45 carries out communication with the communication section 30 (see FIG. 4) in the domestic device control section 3. Because a plurality of domestic device control sections 3 are connected to one center system 4, it is preferable that network communication be employed for communication between the domestic device communication section 45 and the communication section 30.

The external device communication section 46 carries out communication with a plurality of mobile telephones 5 (FIG. 2) or with a plurality of PC terminals 6 (FIG. 2) and transmits to the mobile telephone 5 or to the PC terminal 6 a message corresponding to the ID information/attribute information in the member information recording medium 2.

The external device communication section 46 creates the message by referring to notification message information stored in the recording section. The notification message information is built up of text data, audio data, image data, or others, all of which express a certain communication content.

The control section 42 solely controls processing in the center system 4 and includes an external processing content determination section 47 and an external processing ordering section 48.

The external processing content determination section 47 determines which external device should carry out which external processing based upon the external processing execution information received by the domestic terminal communication section 44. In accordance with the determination of the external processing content determination section 47, the external processing ordering section 48 gives the domestic device communication section 45 an order for transmitting the external processing execution information, or gives the external device communication section 46 an order for transmitting a message to the mobile telephone 5 or to the PC terminal 6.

The external processing execution information is transmitted from the domestic device communication section 45 to the communication section 30 in the domestic device control section 3 so that processing similar to the one in which the external processing execution information is transmitted from the domestic device communication section 15 in the domestic terminal 1 is realized. In other words, the domestic device operation ordering section 33 controls the domestic device in such a way in which the respective domestic devices carry out operation corresponding to the ID information/attribute information of a member.

[6. Procedure of Processing Executed When a Member Returns]

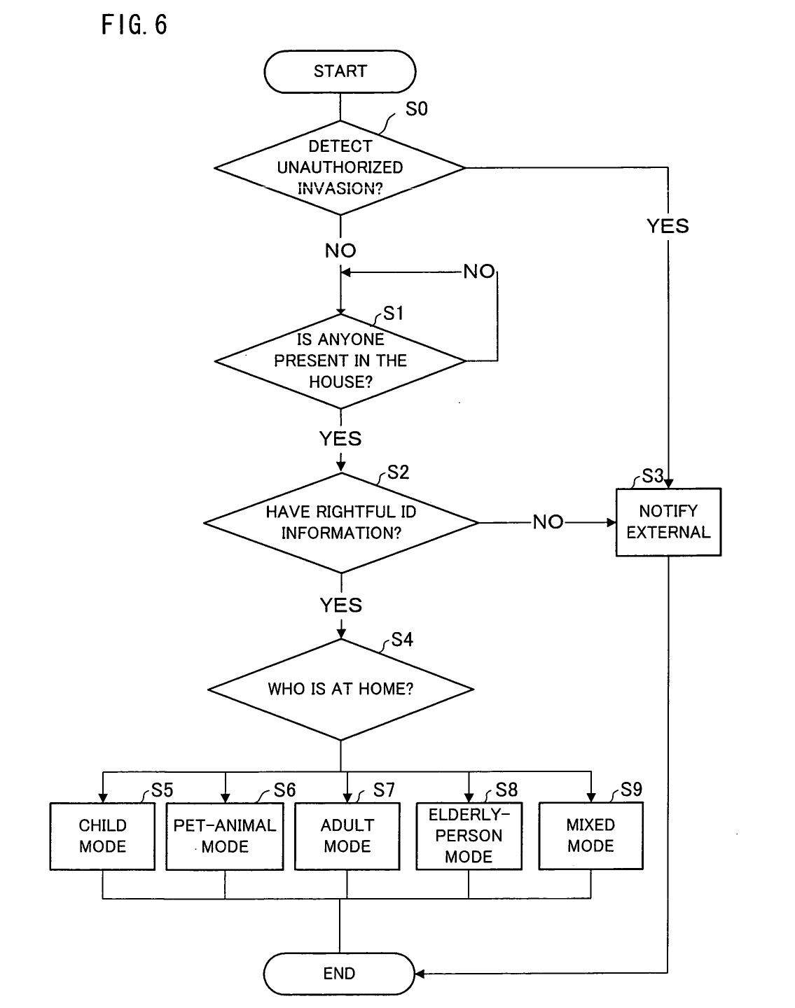

FIG. 6 is a flow chart that illustrates processing carried out by the security management system when a member possessing the member information recording medium 2 returns home. As illustrated in FIG. 6, the unauthorized invasion detection section 18a in the domestic terminal 1 determines whether or not there has been an unauthorized invasion of the house (Step 0)(a step will be simply indicated as S hereinafter).

If it is determined in S0 that there has been an unauthorized invasion, the external processing decision section 21 in the domestic terminal 1 decides to carry out a process, as an external process, in which the center system communication section 16 notifies the center system 4 through the center system communication section 16 that there has been an unauthorized invasion (S3).

On the other hand, if it is determined in the S0 that there has been no unauthorized invasion, the at-home determination section 18b in the domestic terminal 1 determines whether or not there is anyone in the house (S1). Processing in S1 may be carried out, for example as described above, by having the at-home determination section 18b determine whether or not there is a reachable member information recording medium 2 in the communication zone in which a short-distance wireless communication can be carried out with the recording medium communication section 14.

If it is determined in S1 that no one is in the house, the process of S1 will be executed again. On the other hand, if it is determined that someone is in the house, the member information obtaining section 19 in the domestic terminal 1 determines whether or not the member information recording medium 2 has rightful ID information (S2).

If it is determined in S2 that the member information recording medium 2 does not have rightful ID information, the external processing decision section 21 in the domestic terminal 1 carries out a process, as an external process, in which the center system communication section 16 notifies the center system 4 that the member information recording medium 2 having unrightful ID information is present in the house (S3). A security alarm in the house may be activated to sound in S3.

In the center system 4, when the domestic terminal communication section 44 receives such external processing execution information indicating the external process determined in the way described above, in accordance with the order from the external processing ordering section 48, the external device communication section 46 carries out a process in which an electronic mail/audio data which notifies that there is a high possibility of the presence of an illegal intruder in the house is transmitted to the mobile telephone 5 or to the PC terminal 6. An electronic mail/audio mail including the same content may be transmitted from the external device communication section 17 in the domestic terminal 1 to the mobile telephone 5 or to the PC terminal 6.

Further, if it is determined in S2 that the member information recording medium 2 has rightful ID information, the member information obtaining section 19 determines which member is in the house (S4). The determination in S4 is carried out by having the member information obtaining section 19 determine the attribute information of the member information recording medium 2.

If it is determined in S4 that only a child is in the house, the external processing decision section 21 creates external processing execution information in such a way that an external process in a “child mode (description thereof will be mentioned below)” is carried out. Based upon the external processing execution information, operation in the domestic device control section 3 or in the center system 4 is controlled (S5).

If it is determined in S4 that only a pet is in the house, the external processing decision section 21 creates external processing execution information in such a way that an external process in a “pet mode (description thereof will be mentioned below)” is carried out. Based upon the external processing execution information, operation of the domestic device control section 3 or of the center system 4 is controlled (S6).

If it is determined in S4 that an adult is in the house, the external processing decision section 21 creates external processing execution information in such a way that an external process in an “adult mode (description thereof will be mentioned below) is carried out. Based upon the external processing execution information, operation of the domestic device control section 3 or of the center system 4 is controlled (S7).

If it is determined in S4 that only an elderly person is in the house, the external processing decision section 21 creates external processing execution information in such a way that an external process in an “elderly-person mode (description thereof will be mentioned below)” is carried out. Based upon the external processing execution information, operation of the domestic device control section 3 or of the center system 4 is controlled (S8).

If it is determined in the S4 that both an elderly person and a child are in the house, the external processing decision section 21 creates external processing execution information in such a way that an external process in a “mixed mode (description thereof will be mentioned below)” is carried out. Based upon the external processing execution information, operation of the domestic device control section 3 or of the center system 4 is controlled (S9).

The series of processing terminates when one of steps S3, S5, S6, S7, S8, or S9, is carried out.

The following specifically describes the external process in the child mode, adult mode, and elderly-person mode, respectively.

[6-1. Child Model

The external process in the “child mode” is a domestic device operation control process that is suitable for a situation in which only a child is in the house and includes processing for transmitting a message to the mobile telephone 5 or to the PC terminal 6.

If, for example, a gas appliance is operable when only a child is in the house, the child may play with the gas appliance, and consequently cause a fire. Therefore, it is undesirable for a gas appliance to be operational. In addition, if the home-lock is unlocked in the same situation, a burglar can easily enter the house, and the child may be attacked by the burglar. Therefore, it is not desirable that a home-lock is unlocked. Further, if all of the home-sensors are off, there is a problem similar to the one in the situation in which the home-lock is unlocked. Therefore, it is undesirable for all of the home-sensors to be off.

The external processing decision section 21, therefore, creates external processing execution information for the domestic device operation ordering section 33 to carry out an external process in the “child mode” where (i) the gas appliance is made to be unavailable, (ii) all of the home-sensors are turned on, and (iii) all of the home-locks are locked. The external processing execution information is transmitted to the domestic device control section 3 through the domestic device communication section 15 and the communication section 30. External processing execution information including the same content as the one described above may be transmitted to the domestic device control section 3 through the center system 4.

The following describes a process in which a message is transmitted to the mobile telephone 5 or the PC terminal 6, the process being an external processing in the child mode. The external process in the child mode includes processing in which information (member entrance/exit information) in the form of an electronic mail, audio data, or image data and indicating that a child has returned home is transmitted to the mobile telephone 5 or to the PC terminal 6 by using the external device communication section 17 in the domestic terminal 1 or the external device communication section 46 in the center system 4.

A person in charge of overseeing the security of a child (the person will be referred simply as a guardian hereinafter), such as a parent of the child, a relative, a teacher, or others, can be informed by referring to the mobile telephone 5 or the PC terminal 6 that the child has returned home safely. Therefore, the security management system in the embodiment can assure the guardian that the child has returned home even when the guardian is outside of the house.

By having information regarding the time at when a child returns home (time information) included in the message, it becomes possible to more accurately notify the guardian that the child has returned home. In knowing what time the child returns home, the guardian may derive an inference on a situation such as a situation in which the child took a side trip on his/her way back home or a situation in which the child has been involved in trouble. Therefore, having the time at when the child returns home included in the message can provide the guardian an enhanced feeling of security.

In the child mode, processing in which any other object that is dangerous for a child to use is made unavailable may be carried out. For example, in the child mode, external processing execution information for execution of processing in which a fan or an insecticide is made unavailable may be transmitted to the domestic device control section 3.

[6-2. Pet-Animal Mode]

The external process in the “pet mode” is a domestic device operation control process suitable for a situation in which only a pet animal is present in the house and includes a process of transmitting a message to the mobile telephone 5 or to the PC terminal 6.

In the situation in which only a pet animal is present in the house, likewise in the situation in which only a child is present in the house, it is undesirable that a gas appliance is available. In addition, it is also undesirable in the situation in which only a pet-animal is present in the house that the home-lock is unlocked or that the home-sensor is off. Therefore, the external processing decision section 21 creates external processing execution information in such a way that external processing that is basically the same as the one in the child mode is carried out.

Further, in the pet-animal mode, the following process is carried out as an external process. In the situation in which only a pet-animal is present in the house, there is no one to feed the pet-animal with water and food. This situation is undesirable from the standpoint of healthcare of the pet-animal.

Therefore, in the pet-animal mode, processing where a feeding device that feeds a pet-animal with water and food is set to activate at a certain time is carried out as external processing. This enables the pet-animal to be fed even when only the pet-animal is present in the house, thereby preventing health of the pet-animal to be harmed.

[6-3. Adult Mode]

The following describe the external process in the “adult mode”. The external process in the “adult mode” has a domestic device operation control process suitable for a situation in which an adult is present in the house and further a process of transmitting a message to the mobile telephone 5 or to the PC terminal 6.

In the situation in which an adult is present in the house, it is undesirable that a gas appliance is unavailable because if so, housekeeping, such as cooking or hot-water supplying, that requires a use of the gas appliance cannot be carried out. The home-lock may be unlocked, and the home-sensor may be off because an adult is capable of properly defending himself/herself against an intruder to the house.

Therefore, the external processing decision section 21 creates external processing execution information for the domestic device operation ordering section 33 to carry out a process in which a gas appliance is made available, all of the home sensors are off, and all of home-locks are unlocked, the process being as an external process in the “adult mode”. The external processing execution information is transmitted to the domestic device control section 3 through the domestic device communication section 15 and the communication section 30. External processing execution information including the same content as the one described above may be transmitted to the domestic device control section 3 through the center system 4.

The process of transmitting a message to the mobile telephone 5 or to the PC terminal 6 is basically the same as the process carried out in the child mode. By having a message indicating that an adult has returned home (member entrance/exit information) transmitted to the mobile telephone 5 or to the PC terminal 6, a person such as a spouse, a relative, a manager of an apartment, or others can know that an adult has returned home safely and can feel assured.

[6-4. Elderly-Person Mode]

The following describes an external process in the “elderly-person mode”. The external process in the “elderly-person mode” has a domestic device operation control process suitable for a situation in which only an elderly person is present in the house and further a process of transmitting a message to the mobile telephone 5 or to the PC terminal 6.

In the elderly-person mode, basically external process that is the same as the one in the child mode is carried out. The following process is additionally included from the perspective that health of an elderly person should be carefully monitored.

A body sensor and a pulse sensor (physical condition detection instrument) (not-illustrated) are disposed in the member information recording medium 2, and a physical condition of the elderly person carrying the member information recording medium 2 is detected by the sensors. Further, a vibration sensor may be disposed in the member information recording medium 2 so as to detect movement of the elderly person.

Information regarding the physical condition of the elderly person (physical condition management information) detected by the sensors is recorded as attribute information in the member information recording section 8 in the member information recording medium 2. Then, based upon the information regarding the physical condition of the elderly person obtained by the recording medium communication section 14 in the domestic terminal 1 as attribute information, the center system communication section 16 or the external device communication section 17 creates a message indicating the physical condition of the elderly person. Accordingly, the external processing decision section 21 can perform a process in which a message indicating the physical condition of an elderly person is included in the message that is to be transmitted from the domestic terminal 1 to the mobile telephone 5 or to the PC terminal 6, the processing being as external processing.

The message transmitted from the domestic terminal 1 notifies a person out of the house of a physical condition of the elderly person being present in the house, thereby assuring the person.

[6-5. Mixed Mode]

The external process in the “mixed mode” is a domestic device operation control process suitable for a situation in which both an elderly person and a child are present in the house and includes a process of transmitting a message to the mobile telephone 5 or to the PC terminal 6.

In the mixed mode, the process in the elderly-person mode and in the child mode is concurrently carried out. In other words, a process in which a dangerous domestic device is made unavailable and a process in which member entrance/exit information indicating that a child or an elderly person has returned home is transmitted to the mobile telephone 5 or to the PC terminal 6 are carried out. In addition, a process in which a message indicating the physical condition of the elderly person is transmitted from the domestic terminal 1 to the mobile telephone 5 or to the PC terminal 6 is carried out in the mixed mode.

[6-6. Supplemental Description on the Respective Modes]

In the child mode, the adult mode, and the elderly-person mode, the process in which a message notifying which member is present in the house is transmitted from the domestic terminal 1 to the mobile telephone 5 or to the PC terminal 6 is carried out, the process being as external processing. However, if such a message from which the person present in the house can be identified is transmitted, a stranger may figure out the person currently present in the house. This is undesirable from the standpoint of privacy protection and security securement.

Therefore, the message to be transmitted in the respective modes may be encrypted and transmitted to the mobile telephone 5 or to the PC terminal 6. In addition, access to the message may require an input of a predetermined password. This prevents a stranger from figuring out the person currently being present in the house. Therefore, the privacy of the person present in the house can be protected, and security can be assured.

[7. Process Flow for When a Member Is Leaving]

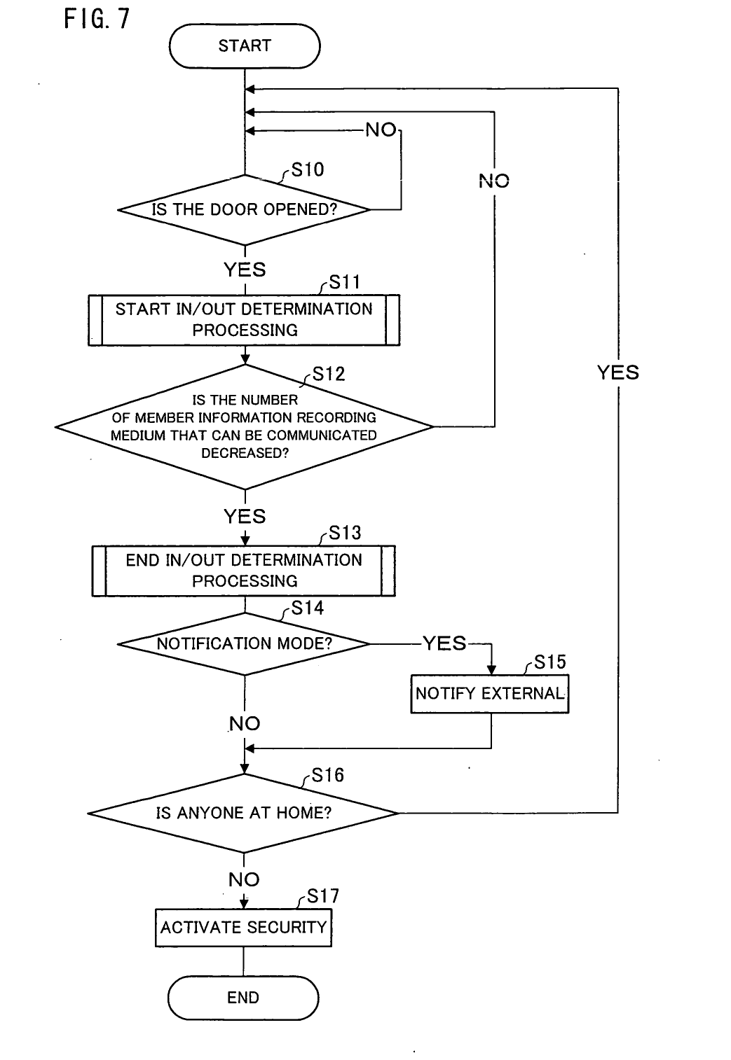

FIG. 7 is a flow chart that illustrate a process that the security management system carries out when the member of the member information recording medium 2 is leaving. As illustrated in FIG. 7, initially, the at-home determination section 18b in the domestic terminal 1 determines whether or not a door of the house opens (S10). The determination in S10 is carried out by having the at-home determination section 18b detect a signal from an open/close sensor (not illustrated) disposed on the door.

If it is determined in S10 that the door is not opened, determination in S10 is carried out again. On the other hand, if it is determined in S10 that the door is opened, the at-home determination section 18b starts carrying out in/out determination processing (S11).

The in/out determination processing implies processing for determining whether or not anyone goes out from the house. The in/out determination processing can be actualized in various ways. For example, the at-home determination section 18b may determine whether or not a number of member information recording mediums 2 communicating with the recording medium communication section 14 decreases (S12) in order to realize the in/out determination processing. Further, the member information recording medium 2 may be structured in such a way where a signal indicating that a member goes out is transmitted to the domestic terminal 1 by an operation carried out by a member. The at-home determination section 18b determines whether or not the recording medium communication section 14 receives the signal so as to realize the in/out determination processing. Further, a GPS (Global Positioning System) may be disposed in the member information recording medium 2, and determination is made on whether or not the place of the member information recording medium 2 detected by the GPS is in the house so as to realize the in/out determination processing.

If the at-home determination section 18b determines in the S12 that the number of member information recording mediums 2 that can be communicated with has not decreased, the at-home determination section 18b carries out the determination in S10 again. In a similar manner, when it is determined in another in/out determination processing that no one goes out from the house, the determination in S10 is carried out again.

On the other hand, if the at-home determination section 18b determines in S12 that the number of the member information recording mediums 2 that can be communicated has decreased, the in/out determination processing ends (S13). In a similar manner, if it is determined in another in/out determination processing that anyone has gone out from the house, the in/out determination processing ends.

Subsequent to the processing in S13, the external processing decision section 21 determines whether or not the domestic terminal 1 is set in a notification mode (S14). The notification mode is a mode in which a process where a message notifying that the member goes out (member entrance/exit information) is transmitted to the mobile telephone 5 or to the PC terminal 6 when a member in the house goes out, the process being an external process.

If it is determined in S14 that the domestic terminal 1 is set in the notification mode, the external processing decision section 21 decides to carry out the process in which a message, such as an electronic mail or audio data, notifying that a person who was present in the house has gone out is transmitted to the mobile telephone 5 or to the PC terminal 6, as an external process (S15).

It is preferable that the message at least indicate the person having gone out. Further, from the standpoint of assuring security and protecting privacy, it is not preferable that a stranger figure out who goes out. Therefore, the message should be protected with a password.

On the other hand, if it is determined in S14 that the domestic terminal 1 is not set in the notification mode, the at-home determination section 18b determines whether or not anyone is present in the house (S16). The determination in S16 is carried out by the at-home determination processing descried above.

If it is determined in S16 that someone is present in the house, the processing goes back to S10. On the other hand, if it is determined in S16 that no one is present in the house, the external processing decision section 21 decides execution of an external process in which security is turned on (S17).

The external process in which security is turned on implies processing in which all of the home sensors are turned on and all of the home-locks are locked. In addition, processing in which a lighting device is turned off, an air-conditioner is turned off, and a gas appliance is made unavailable is also included in the external process in which the security is turned on. Carrying out the external process provides an improved prevention of crime or fire when no one is in the house.

In the process from S10 to S12, the opening/closing of the door is used to trigger execution of the in/out determination process. An invention having the aforesaid feature has the following flow of processing.

The invention is in connection with a security management method including (i) a first step in which an opening/closing of a doorway (door) to the security management region that is subject to security management is detected and (ii) a second step in which an entrance/exit of a member to/from the security management region is confirmed based upon the detection result in the first step.

In the invention with the above arrangement, the opening/closing of the doorway to the security management region triggers a confirmation of an entrance/exit of a member to/from the security management region. Because the opening/closing of the doorway is always necessary for a member to enter/exit from the security management region, in the structure described above, the entrance/exit of a member to/from the security management region can be accurately determined.

The second step can be realized by performing the same process as the one in the in/out determination process. For example, the second step can be realized by carrying out the process in which it is determined whether or not a number of the member information recording medium that can be communicated with the security management device has decreased in a case in which the member carries the member information recording medium that can be communicated with the security management device disposed in the house.

In addition, by notifying an outside person of information regarding the entrance/exit of a member that is confirmed in the second step, the person who is outside of the security management region can be notified of the entrance/exit of a member to/from the security management region and can feel assured.

Finally, the respective blocks in the domestic terminal 1 may be structured with hardware logic or, as described below, software by using a CPU.

The domestic terminal 1 includes a CPU (central processing unit) that executes a command of a control program for realizing the respective functions, a ROM (read only memory) that stores the program, a RAM (random access memory) that develops the program, a recording device (recording medium) such as a memory that stores the program and various data, or the like. The object of the present invention can be achieved by (i) providing the domestic terminal 1 with a recording medium in which program code (execution format program, intermediate code program, source program) in the control program of the domestic terminal 1, which is software realizing the functions described above, is recorded in such a way as to be readable by a computer and (ii) having the computer (or CPU or MPU) read out and execute the program code recorded in the recording medium.

The following may be used as the recording medium: a tape such as an electromagnetic tape or a tape cassette, a disk such as an electromagnetic tape, for example a floppy (registered trademark) disk, a hard disk or the like, or an optical disk, for example a CD-ROM, a MO, a MD, a DVD, a CR-R or the like, a card such as an IC card (including a memory card), an optical card or the like, a semiconductor memory such as a mask ROM, an EPROM, an EEPROM, a flash ROM or the like.

Further, the domestic terminal 1 may be structured in such a way that the domestic terminal 1 can be connected to the communication network, and the program code may be provided through the communication network. A variety of networks can be used as the communication networks. Examples thereof are Internet, intranet, extranet portal, LAN, ISDN, VAN, CATV communication networks, virtual private networks, telephone communication networks, mobile communication networks, and satellite communication networks. Further, a variety of mediums, including a wired line and a radio transmission, can be used as the transmission medium constructing the communication network. Examples of the wired line are an IEEE 1394, USB, a power-line carrier, a cable television circuit, a telephone line, and an ADSL line. Examples of the radio transmission are infrared-ray such as IrDA or a remote control, Bluetooth, 802.11 radio transmission, HDR, mobile telephone networks, satellite connections, and terrestrial digital networks. The present invention may also be actualized with a carrier wave in which the program code is realized with electronic transmission or a data signal sequence.

As described above, a security management device in the present invention includes a presence/absence determination instrument, a member information obtaining instrument, and a security management mode changing instrument. Further, a security management method includes a first step in which the presence/absence determination instrument is used, a second step in which the member information obtaining instrument is used, and a third step in which the security management mode changing instrument is used.

In the above structure, because a security management mode is changed by the security management mode changing instrument based upon the attribute information of a member obtained by the member information obtaining instrument, the security management mode can be changed in such a way as to correspond to the attribute of the member present in the security management region. Therefore, in the present invention, a security management mode appropriate for a member present in the security management region can be set.

Further, as described above, the security management device in the present invention may be one in which, if it is determined by the member information obtaining instrument based upon the attribute information obtained by the member information obtaining instrument that the member present in the security management region is a child only, the security management mode changing instrument changes the security management mode in the security management region to a security management mode whose security level is higher than a security level of a security management mode employed in a case in which the member information obtaining instrument determines that an adult is included as a member present in the security management region.

A security capacity of a member against an intruder from outside differs depending upon his/her age. For example, if the member is a child, his/her security capacity against an intruder from outside is normally low. If the member is an adult, his/her security capacity against an intruder from outside is high.

In the above structure, when only a child member is present in the security management region, the security management mode whose security level is higher than the security level of a management mode employed in the case in which an adult is present in the security management region is set. Therefore, security in the security management region can be assured at higher level.

Further, as described above, the security management device in the present invention may include a member identification processing instrument and an external device notification instrument in the above structure.

In the above structure, if the member identification processing instrument carries out an identification process on a member determined as being present in the house, the member can be identified. In addition, the external device notification instrument notifies an external device of member entrance/exit information based upon a result of an identification process carried out by the member identification processing instrument. Therefore, who enters/exits from the house can be known at a place remote from the security management device.

Accordingly, for example by using the external device described above, a parent away from the house can know from outside a situation of an entrance/exit of a member of the house, for example a situation of the returning/leaving of a child to/from a house. This gives the parent a feeling of security.

As described above, a security management device in the present invention can provide a member with the feeling of security arising from being able to know who enters/exits from the security management region, even when the member is away from the security management device.

Further, as described above, a security management device in the present invention may be one in which the member entrance/exit information includes time information regarding a time at when a member enters/exits from the security assurance region.

In the above structure, because the time information is included in the member entrance/exit information, by using the external device described above, a parent, who is away from the house, can know the time of entrance/exit of a member to/from the house, for example the returning time and leaving time of a child-.

Accordingly, one can accurately know who enters/exits from the security management region at what time even if he/she is away from the security management device. Therefore, an enhanced feeling of security can be provided to him/her.

Further, as described above, a security management device in the present invention may be one in which the member entrance/exit information includes physical condition management information regarding physical condition of a member present in the security management region.

In the above arrangement, because the member entrance/exit information includes the physical condition management information, such as information on body temperature or a pulse of the member, using the external device mentioned above, a person away from the house, acting as the security management region, can monitor the physical condition of a member in the house. Especially in a case in which the member is an elderly person, it is highly necessary to comprehend in real time the physical condition of the elderly person even from a place away from the house.

Therefore, the physical condition of a member in the security management region can be accurately known even from a place away from the security management device. This can provide the member with an enhanced peace of mind. Especially, being able to notify a person who is away from the security management region of the physical condition of an elderly person who is in the region, the security management device in the present invention can provide an enhanced feeling of security to the member.

Further, as described above, it is preferable that the security management device in the present invention obtain physical condition management information from the member information recording medium through the member information recording medium communication instrument, the physical condition management information being created by the physical condition detection instrument disposed in the member information recording medium and which physical condition detection instrument detects the physical condition of the member.

In the above arrangement, the physical condition management information can be created with a simple structure in which the physical condition detection instrument, such as a body temperature sensor or a pulse sensor, is disposed in the member information recording medium. In addition, the physical condition management information structure in the way described above can be easily obtained from the member information recording medium through the member information recording medium communication instrument.

Therefore, a feeling of security can be given to a person in a place away from the security management region with a simple process.

Further, as described above, it is preferable that a security management device in the present invention be one in which the member identification processing instrument carries out a process of identifying the member by determining whether the ID information obtained from the member information recording medium through the member information recording medium is included in the allowed member information so as to carry out an identification process of the member.

In the above structure, the member carries the member information recording medium in which the ID information is recorded, and the allowed member information is recorded in the recording instrument. This allows the member identification instrument in the security management device to more simply carry out the identification processing. Therefore, the security management device can provide the member with a feeling of security while employing a simple structure.

Further, as described above, it is preferable that a security management device in the present invention determine whether the member information recording medium and the member information recording medium communication instrument can communicate with each other in order to determine the presence/absence of a member in the security management region.

In the above structure, making a member carry the member information recording medium allows the presence/absence determination instrument to easily carry out the processing of determining presence/absence of a member. Therefore, the security management device can provide the member feeling of security by employing simpler structure.

The respective steps in the security management method may be carried out on a computer as a security management program. Moreover, storing the security management program in a computer-readable recording medium makes it possible to execute the security management program on a computer.

It will be obvious that the invention thus described may take many variations. Such variations are not to be regarded as a departure from the spirit and scope of the invention, as all such variations would be obvious to one skilled in the art, and are hence intended to be included within the scope of the following claims.

### INDUSTRIAL APPLICABILITY

In the present invention, a security management mode changing instrument changes the security management mode depending upon the attribute of the member present in the security management region. The security management mode can be set appropriately for the member present in the security management region. Therefore, the present invention is suitable especially in the field of home-security for assuring safety in a house.

1. A security management device comprising unauthorized invasion detection means for detecting an unauthorized invasion of a security management region that is subject to security management, and raising an alarm when the unauthorized invasion detection means detects the unauthorized invasion, comprising:
presence/absence determination means for determining the presence/absence of a member in the security management region;
member information obtaining means for obtaining attribute information of a member whom the presence/absence determination means determines as being present in the security management region; and
security management mode changing means for changing a security management mode in the security management region based upon the attribute information of a plurality of members obtained by the member information obtaining means, when unauthorized invasion detection means detects no unauthorized invasion.

2. A security management device as set forth in claim 1, wherein, if it is determined by the member information obtaining means based upon the attribute information obtained by the member information obtaining means that the member present in the security management region is a child only, the security management mode changing means changes the security management mode in the security management region to a security management mode whose security level is higher than a security level of a security management mode employed in a case in which the member information obtaining means determines that an adult is included as a member present in the security management region.

3. A security management device as set forth in claim 1, further comprising:
member identification processing means for carrying out an identification process for identifying a member determined by the presence/absence determination means as being present in the security management region; and
external device notification means for notifying an external device of member entrance/exit information indicating who enters/exits from the security assurance region, based upon a result of the identification process carried out by the member identification processing means.

4. A security management device as set forth in claim 3, wherein the member entrance/exit information includes time information regarding a time at when a member enters/exits from the security assurance region.

5. A security management device as set forth in claim 3, wherein the member entrance/exit information includes physical condition management information on a physical condition of a member present in the security management region.

6. A security management device as set forth in claim 5, further comprising member information recording medium communication means operable to communicate with the member information recording medium carried by the member, wherein
the physical condition management information is obtained from the member information recording medium through the member information recording medium communication means, the physical condition management information being created by the physical condition detection means disposed in the member information recording medium and which physical condition detection means detects the physical condition of the member.

7. A security management device as set forth in claim 3, further comprising:
member information recording medium communication means operable to communicate with the member information recording medium being carried by the member, which member information recording medium storing the ID information of the member; and
recording means for recording the ID information of a member allowed to be in the security management region as allowed member information, wherein
the member identification processing means determines whether the ID information obtained from the member information recording medium through the member information recording medium communication means is included in the allowed member information so as to carry out an identification process of the member.

8. A security management device as set forth in claim 1, further comprising, in a zone including the security management region, member information recording medium communication means operable to communicate with the member information recording medium carried by the member, wherein
the presence/absence determination means determines whether the member information recording medium and the member information recording medium communication means can communicate with each other in order to determine the presence/absence of a member in the security management region.

9. A security management method in which unauthorized invasion detection means in a security management device detects an unauthorized invasion of a security management region that is subject to security management, and the security management device raises an alarm when the unauthorized invasion is detected by the unauthorized invasion detection means, comprising:
a first step in which the presence/absence of a member in the security management region is determined by the presence/absence determination means in the security management device;
a second step in which attribute information of a member whom the presence/absence determination means determines as being present in the security management region is obtained by member information obtaining means in the security management device; and
a third step in which a security management mode in the security management region is changed by the security management mode changing means in the security management device based upon the attribute information of a plurality of members obtained by the member information obtaining means, when the unauthorized invasion detection means detects no unauthorized invasion.

10. A security management method as set forth in claim 9, wherein the third step is a step in which, if it is determined by the member information obtaining means based upon the attribute information obtained by the member information obtaining means that the member present in the security management region is a child only, the security management mode changing means changes the security management mode in the security management region to a security management mode whose security level is higher than a security level of a security management mode employed in a case in which the member information obtaining means determines that an adult is included as a member present in the security management region.

11. A security management method as set forth in claim 9, further comprising:
a fourth step in which member identification processing means in the security management device carries out an identification process for identifying a member determined by the presence/absence determination means as being present in the security management region; and
a fifth step in which based upon a result of the identification process in the fourth step, an external device is notified of member entrance/exit information indicating who enters/exits from the security assurance region through external device notification means in the security management device.

12. A security management method as set forth in claim 11, wherein the member entrance/exit information includes time information regarding a time at when a member enters/exits from the security assurance region.

13. A security management method as set forth in claim 11, wherein the member entrance/exit information includes physical condition management information regarding a physical condition of a member present in the security management region.

14. A security management method as set forth in claim 13, wherein:
the security management device further comprises member information recording medium communication means operable to communicate with the member information recording medium carried by the member; and
the physical condition management information is obtained from the member information recording medium through the member information recording medium communication means, the physical condition management information being created by the physical condition detection means disposed in the member information recording medium and which physical condition detection means detects the physical condition of the member.

15. A security management method as set forth in claim 11, wherein:
the security management device comprises member information recording medium communication means operable to communicate with the member information recording medium being carried by the-member, which member information recording medium storing the ID information of the member;
the security management device further comprises recording means in which ID information of a member allowed to be in the security management region is recorded as allowed member information; and
the fourth step is a step in which the member identification processing means determines whether the ID information obtained from the member information recording medium through the member information recording medium communication means is included in the allowed member information so as to carry out an member identification process.

16. A security management method as set forth in claim 9 wherein:
the security management device comprises, in a zone including the security management region, member information recording medium communication means operable to communicate with a member information recording medium carried by a member; and
the first step is a step in which the presence/absence determination means determines whether the member information recording medium and the member information recording medium can communicate with each other in order to determine the presence/absence of a member in the security management region.

17. A security management program for a computer to execute the respective steps in the security management method set forth in claim 9.

18. A computer-readable recording medium, wherein the security management program set forth in claim 17 is recorded.
